(19) United States
(12) Patent Application Publication
(10) Pub. No.: US 2006/0015400 A1
(43) Pub. Date: Jan. 19, 2006

(54) Processing data for an advertising program conducted in association with a telecommunications network

(76) Inventors: Thomas J. Pinotti, Atlanta, GA (US); John T. Muhs, Marietta, GA (US); Benjamin D. Weiss, Atlanta, GA (US)

Correspondence Address: LEE & HAYES, PLLC, 421 W. RIVERSIDE AVE., SUITE 500, SPOKANE, WA, 99201, US

(21) Appl. No.: 10/890,757

(22) Filed: Jul. 14, 2004

(51) Int. Cl. G06Q 30/00

(52) U.S. Cl. 705/14

(57) ABSTRACT

Embodiments include a method for processing advertising data in a telecommunications service provider. The method may include receiving at least one customer communication in a network of the telecommunications service provider, which includes data obtained from at least one advertisement included within an advertisement medium; forwarding the customer communication to a business entity; activating an advertising data processor operatively associated with the network in response to receiving the customer communication; acquiring advertising data associated with the forwarded customer communication with the advertising data processor; and, accessing at least one directory and at least one other data source with the advertising data processor to obtain data associated with the advertising data acquired from the customer communication, wherein at least one of the other data sources includes demographic data related to the customer communication.

### BACKGROUND

The subject invention generally and in various embodiments relates to methods, systems and computer-readable media configured for use with obtaining, storing, reporting and/or processing advertising data and other related communications data in association with an advertising program in a telecommunications network.

Many business entities advertise in telephone directories to market their goods and services to consumers. Businesses may choose to place advertisements with a telecommunications service provider in a print version of a telephone directory issued by the telecommunications service provider, for example. To measure the success of its advertising investment, a business client may ask the telecommunications service provider to track, store, and/or otherwise process data associated with consumer communications attributed to its advertisements. For example, the business client may request that the telecommunications service provider track the number of telephone calls that originate from a toll-free telephone number associated with a particular print advertisement in a telephone directory.

Historically, telecommunication service providers have not employed advertising programs for business clients that serve as effective revenue-generating vehicles for the telecommunications service providers. For example, a variety of communications data are generated while conducting an advertisement program that may be collected and presented to a business client. Typically, however, these communications data are not presented to the business client in a manner that strongly markets additional services of the telecommunications service provider to the business client. Therefore, conventional ways of collecting and presenting communications data obtained during execution of an advertisement program have not fully maximized the potential for developing new revenue streams derived from a business client.

Based on the foregoing discussion, it can be seen that improved methods, systems, and computer-readable media are needed for tracking, storing, reporting and/or otherwise processing data in connection with execution of an advertisement program in a telecommunications network.

### SUMMARY

Exemplary embodiments of the present invention include a method for processing advertising data in a telecommunications service provider. The method may include receiving at least one customer communication in a network of the telecommunications service provider, which includes data obtained from at least one advertisement included within an advertisement medium; forwarding the customer communication to a business entity; activating an advertising data processor operatively associated with the network in response to receiving the customer communication; acquiring advertising data associated with the forwarded customer communication with the advertising data processor; and, accessing at least one directory and at least one other data source with the advertising data processor to obtain data associated with the advertising data acquired from the customer communication, wherein at least one of the other data sources includes demographic data related to the customer communication.

Exemplary embodiments of the present invention may also include one or more of the following aspects: generating at least one call detail report including, for a given time period for the business entity, a caller number, caller name, address data for the customer, a class designation for the customer, a status of the customer communication, and a duration of the customer communication; generating at least one call analysis report including at least one graphical representation of at least a portion of the acquired advertising data, the graphical representation including at least one of a calls-by-answer-status section, a percentage-calls-by-day-of-week section, and a calls-by-time-of-day section; generating at least one demographic analysis report including at least a portion of the demographic data; and, generating at least one advertising performance report including call volume data for a predetermined time period.

The present invention also provides embodiments of systems for processing advertising data in a telecommunications service provider. The present invention further includes embodiments of computer-readable media including instructions for processing advertising data in a telecommunications service provider.

Other systems, methods, and/or products according to embodiments of the present invention will be or will become apparent to one with skill in the art upon review of the following drawings and detailed description. It is intended that all such additional systems, methods, and/or products be included within this description, be within the scope of the invention, and be protected by the accompanying claims.

### BRIEF DESCRIPTION OF THE FIGURES

FIG. 1 includes a schematic illustrating various aspects of advertising data processing system embodiments provided in accordance with the present invention;

FIG. 2 includes a process flow diagram illustrating various aspects of method embodiments for processing advertising data in accordance with exemplary embodiments;

FIG. 3 illustrates a sample report including data that may be processed in accordance with exemplary embodiments;

FIG. 4 illustrates a sample report including data that may be processed in accordance with various exemplary embodiments;

FIG. 5 illustrates a sample report including data that may be processed in accordance with various exemplary embodiments; and,

FIGS. 6A and 6B illustrate sample reports including data that may be processed in accordance with various exemplary embodiments.

### DESCRIPTION

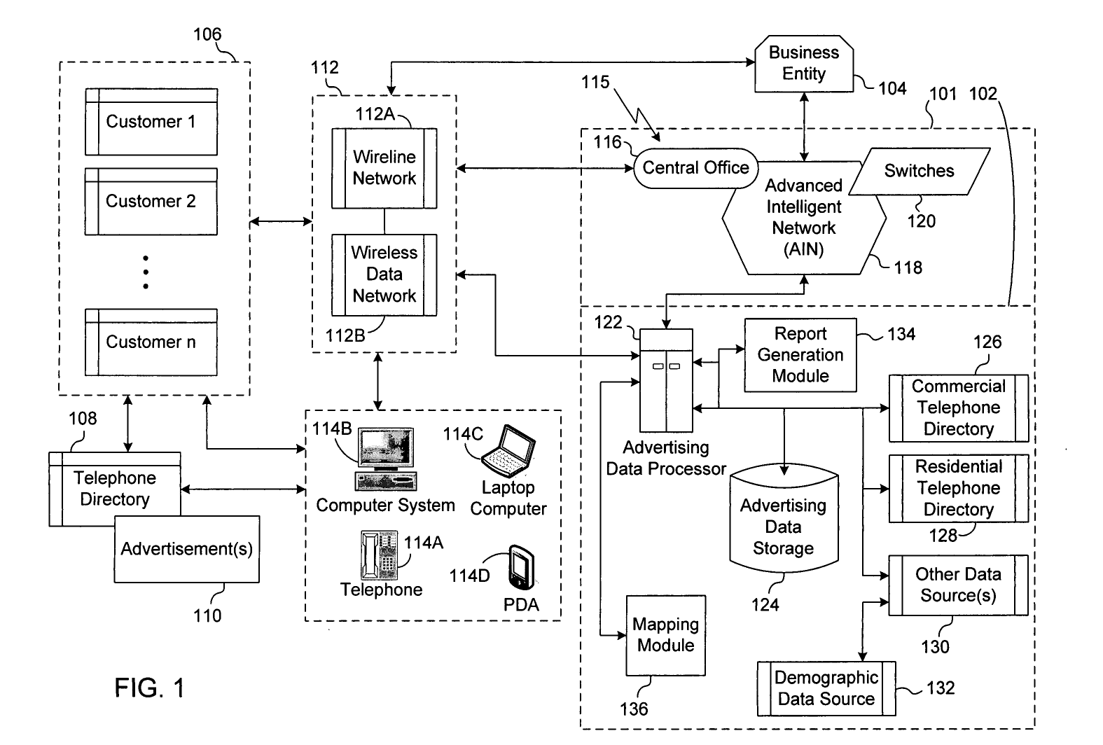

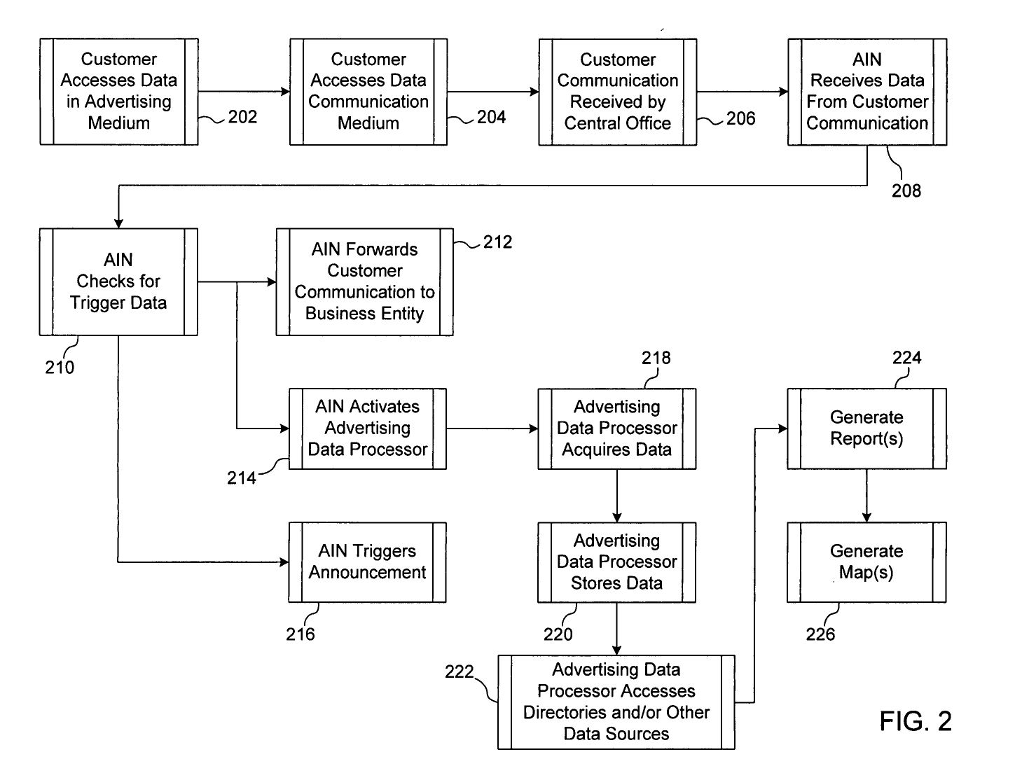

Referring now to FIGS. 1 and 2, various aspects of exemplary system and method embodiments of the present invention are illustrated. As shown, an advertising data processing system 102 of a telecommunications service provider 101 is operatively associated with a business entity 104 which may be an advertising client of the telecommunications service provider 101, for example. In step 202, one or more customers 106 may access data contained within an advertising medium such as a telephone directory 108, for example. The telephone directory 108 may include one or more advertisements 110 for goods or services that are placed with the telecommunications service provider 101 by the business entity 104. For example, in certain embodiments of the invention, the customer 106 may obtain a toll-free telephone number from one of the advertisements 110 that allows the customer 106 to contact the business entity 104 to obtain information related to goods or services offered by the business entity 104.

It can be appreciated that a number of different advertising media (e.g., newspapers, billboards, direct mail (in hard copy or electronic format), Internet sites, television commercials, radio commercials and/or others) may be employed within the scope of the present invention in addition to, or in place of, the use of the telephone directory 108. As applied herein, the term “advertising medium” includes a wide variety of media in which advertisements are displayed, presented and/or accessed including various forms of print advertising media or electronic advertising media. Discussion of the telephone directory 108 herein is provided merely for convenience of disclosure to illustrate a potential advertising medium suitable for use in connection with various embodiments of the present invention.

In step 204, using the data obtained from the telephone directory 108 and/or the advertisements 110 in the telephone directory 108, the customer 106 may access one or more communications media 112 using one or more of a variety of communication access devices 114. As shown, in various embodiments of the invention, the communication media 112 may include, for example and without limitation, a wireline network 112A such as a publicly switched telephone network (PSTN). The communication media 112 may also include, for example, a wireless data network 112B. Examples of communication access devices 114 that may be used by customers 106 include, without limitation, a telephone 114A (e.g., a wireless telephone or a wireline telephone), a computer system 114B, a laptop computer 114C, a personal digital assistant (PDA) 114D, or any other communication access device suitable for use in association with practice of the present invention.

In step 206, a communication from the customer 106 including data obtained from the advertisement 110 is received by a network 115 of the telecommunications service provider 101. As shown, in various embodiments of the invention, within the network 115 a central office 116 may be operatively associated with an advanced intelligent network (AIN) 118 which is configured for operation as understood by those skilled in the telecommunications arts (e.g., such as an AIN employed by BellSouth of Atlanta, Ga.). In various embodiments of the present invention, the AIN 118 may be configured with one or more switches 120 that include trigger data corresponding to data associated with one or more of the advertisements 110. In operation, upon receipt of a communication from the customer 106 including data associated with the advertisement 110 in step 208, the AIN 118 checks in step 210 to determine whether trigger data associated with the advertisement 110 have been programmed into the AIN 118. If the AIN 118 determines the existence of trigger data associated with the advertisement 110, the AIN 118 forwards the customer 106 communication to the business entity 104 in step 212 and activates an advertising data processor 122 in step 214 to collect various data associated with the customer 106 communication. In certain embodiments, the AIN 118 may be further configured to trigger an announcement in step 216 (e.g., “this call is brought to you by The Real Yellow Pages®”) that is played to the customer 106 and/or the business entity 104 in connection with forwarding the customer 106 communication.

It can be appreciated that use of the AIN 118 in the network 115 of the telecommunications service provider 101 may be substituted or supplemented with other devices or systems suitable for processing advertising data in accordance with the present invention. For example, those skilled in the art will appreciate that voice-over-Internet-protocol (VOIP) or Internet telephony technology may be employed in operative association with the network 115. In one aspect, Internet telephony may be used to enable a telephone conversation with the customer 106, for example, wherein the communication is carried over the Internet or a dedicated network in Internet protocol packets, instead of through a dedicated wireline network, for example, configured for voice communications.

For example, a first toll-free telephone number may be associated with a particular advertisement 110, and the AIN 118 may be programmed with trigger data including at least a second telephone number that is programmed for correspondence with the first telephone number. Thus, in this example, when the customer 106 calls the first telephone number, the AIN 118 triggers the second telephone number to activate the advertising data processor 122 to initiate data collection in association with the customer 106 communication. The AIN 118 may also forward the customer 106 communication to a forwarding telephone number associated with a main office, for example, of the business entity 104. In certain embodiments, the business entity 104 may designate one or more additional forwarding telephone numbers in the event that the initial forwarding number is busy, inactive, or as otherwise desired by the business entity 104. For example, to reduce the likelihood of busy signals, the business entity 104 may arrange to have a rollover service (which it may arrange through the telecommunications service provider 101, for example) to allow a telephone call received by the AIN 118 to rollover to a secondary telephone number.

In various embodiments of the present invention, the advertising data processor 122, through its operative association and communication with the AIN 118, may acquire or obtain a variety of advertising data associated with the customer 106 communication in step 218. Examples of acquired advertising data include, without limitation, a telephone number of the customer 106 initiating a communication; duration of a given communication between the customer 106 and the business entity 104; whether a communication between the customer 106 and the business entity 104 was answered or not answered by the business entity 104; and/or whether a customer 106 communication resulted in a busy signal and, if busy, whether the customer 106 communication was answered or not answered by the business entity 104. The advertising data processor 122 may also collect the time and date of a given customer 106 communication. Over time, the advertising data processor 122 develops data related to distribution and volume of customer 106 communications over a given time period (e.g., daily, weekly, monthly, quarterly, yearly, and/or for another desired periodic or non-periodic basis).

In certain embodiments, the business entity 104 may be able to access communication data in the advertising data processor 122 through an Internet connection, for example, or another of the communication media 112. Such Internet access can permit the business entity 104 to review call results, for example, in real-time or near real-time. In addition, an e-mail or other equivalent communication can be configured to be sent automatically to the business entity 104 such as when a customer 106 communication is not answered or results in a busy signal, for example. The business entity 104 may then pursue follow-up communications with customers 106 who experienced a busy signal or whose calls were not answered.

As shown, in various embodiments, data collected by the advertising data processor 122 may be stored in an advertising data storage 124 in step 220 and/or in another suitable data storage medium or media.

In certain embodiments of the present invention, in step 222, the advertising data processor 122 may also access one or more of a commercial telephone directory 126 (e.g., a “yellow pages” or functionally equivalent directory), a residential telephone directory 128 (e.g., a “white pages” or functionally equivalent directory), and/or one or more other data sources 130 including data associated with a customer 106 communication such as a demographic data source 132 including government census data, for example. It can be appreciated that the advertising data processor 122 may link to and cross-reference data collected from the customer 106 communications with data contained in the directories 126, 128 or the other data sources 130. Examples of data that may be obtained by the advertising data processor 122 include, without limitation, customer 106 address information including street addresses and ZIP codes; and census data for a given ZIP code such as age data, ethnic origin data, total population data, household volume data, average income data, and percentage income increase/decrease data.

In various embodiments of the invention, a report generation module 134 may be operatively associated with the advertising data processor 122. The report generation module 134 may be configured for generating in step 224 a variety of reports in association with data gathered and compiled by the advertising data processor 122. In various embodiments, the business entity 104 may receive reports as hard copies (e.g., through regular United States mail or by courier service), via e-mail, or by another suitable method of communication. It can be appreciated that the following samples of reports generated by the report generation module 134 are provided merely for convenience of disclosure to illustrate various aspects of the present invention. No particular aspect or aspects of these sample reports are intended to limit the scope of the present invention. Variations of the details of these sample reports (e.g., selection of different time periods for reporting) are considered within the scope of the present invention.

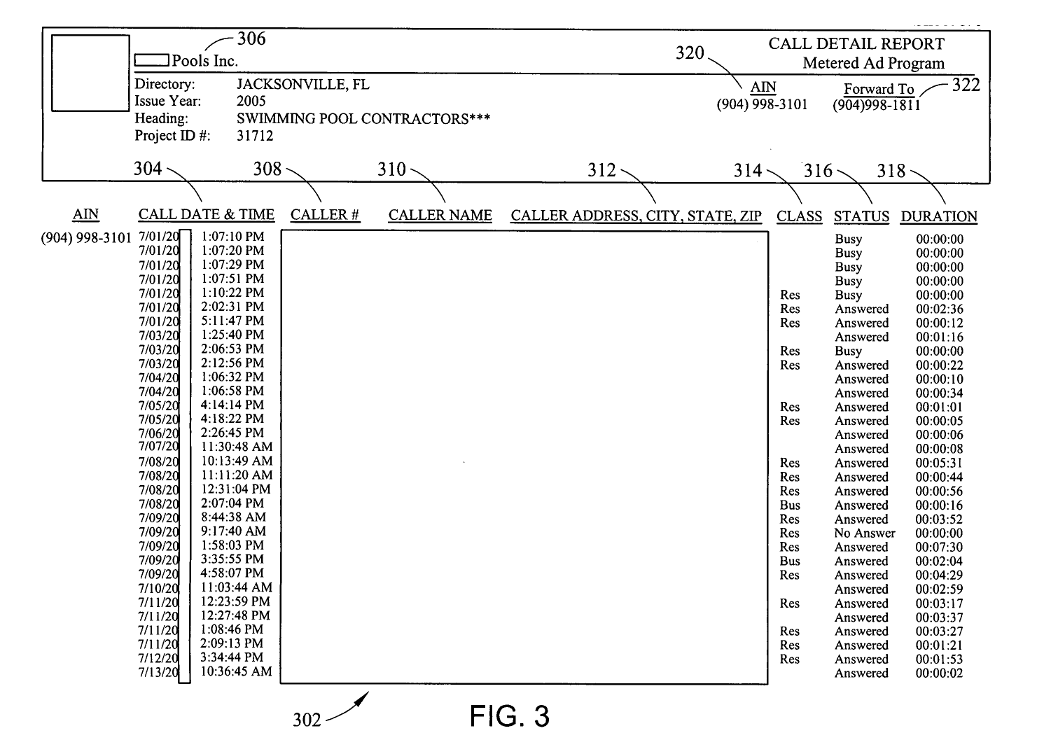

Referring now to FIG. 3, a sample call detail report 302 is shown that can be generated by the advertising data processor 122 in association with the report generation module 134. For a given range of time periods 304 for a given business entity 306, the call detail report 302 may display one or more of the caller number 308 of the customer 106; the caller name 310 for the customer 106; address data 312 for the customer 106; a class designation 314 for the customer (e.g., “Res” for a residential customer, “Bus” for a commercial customer, or “Cel” for a customer calling from a cellular device); a status 316 of the customer 106 communication (e.g., whether the communication resulted in a busy signal, was answered by the business entity 104, or not answered by the business entity 104); and/or a duration 318 of the communication between the customer 106 and the business entity 104. The call detail report 302 may also include the AIN 118 trigger data 320 (e.g., a telephone number), and a “Forward To” number 322 for connecting the customer 106 communication to the business entity 104.

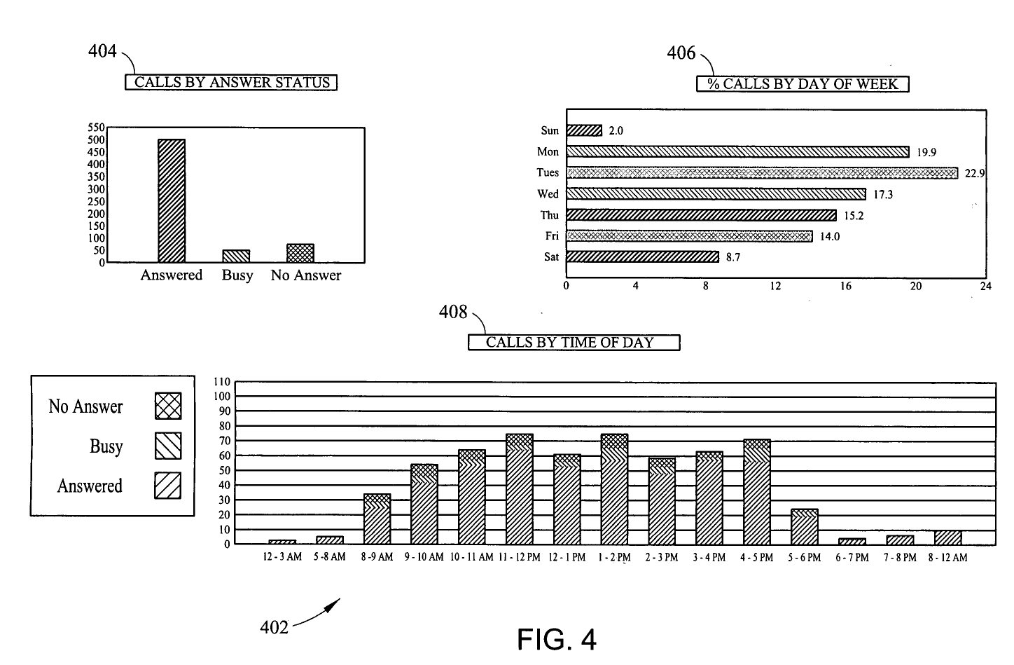

Referring now to FIG. 4, a sample call analysis report 402 is shown that can be generated by the advertising data processor 122 in association with the report generation module 134. A “Calls by Answer Status” section 404 of the report 402 graphically depicts the number of customer 106 communications that were answered or not answered by the business entity 104, or which resulted in a busy signal. A “% Calls by Day of Week” section 406 of the report 402 graphically depicts on a percentage basis the number of customer 106 communications with the business entity 104 on a day-of-the-week basis. A “Calls by Time of Day” section 408 of the report 402 graphically depicts volume of calls for various time segments on a daily basis. As shown, the call volume may be further depicted by call status (e.g., no answer, busy, or answered).

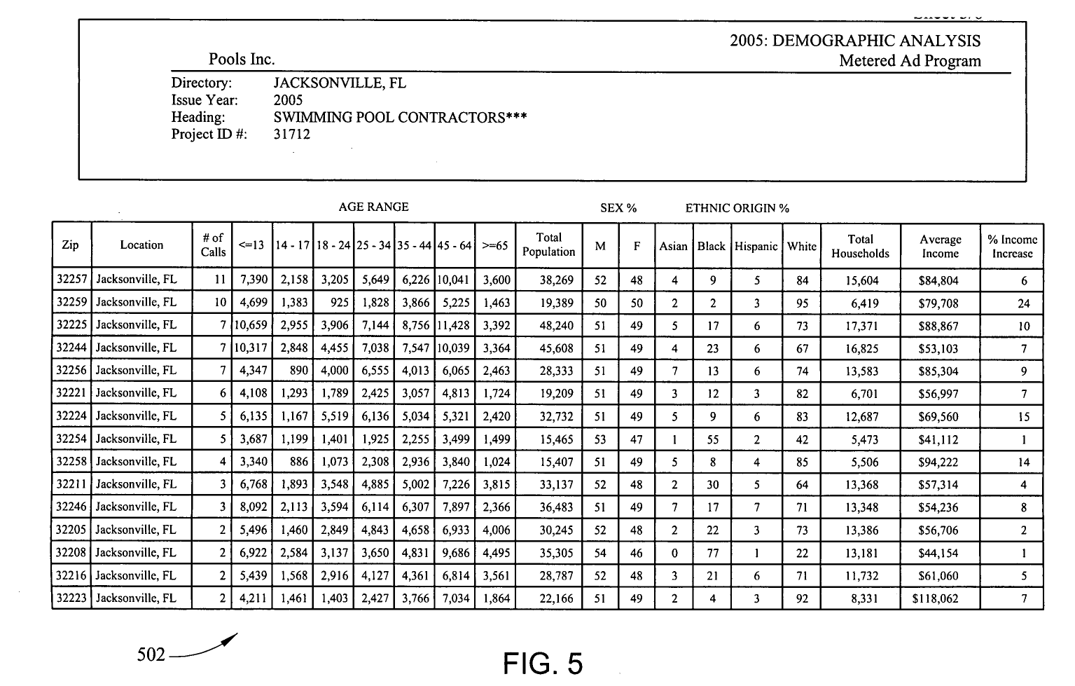

Referring now to FIG. 5, a sample demographic analysis report 502 is shown that can be generated by the advertising data processor 122 in association with the report generation module 134. The demographic analysis report 502 displays various demographic data on a ZIP code basis, for example, for a certain number of customer 106 communications. It can be appreciated that this report 502 may be generated by the advertising data processor 122 accessing and aggregating ZIP code information, for example, from the directories 126, 128, along with census data, for example, obtained from the demographic data source 132.

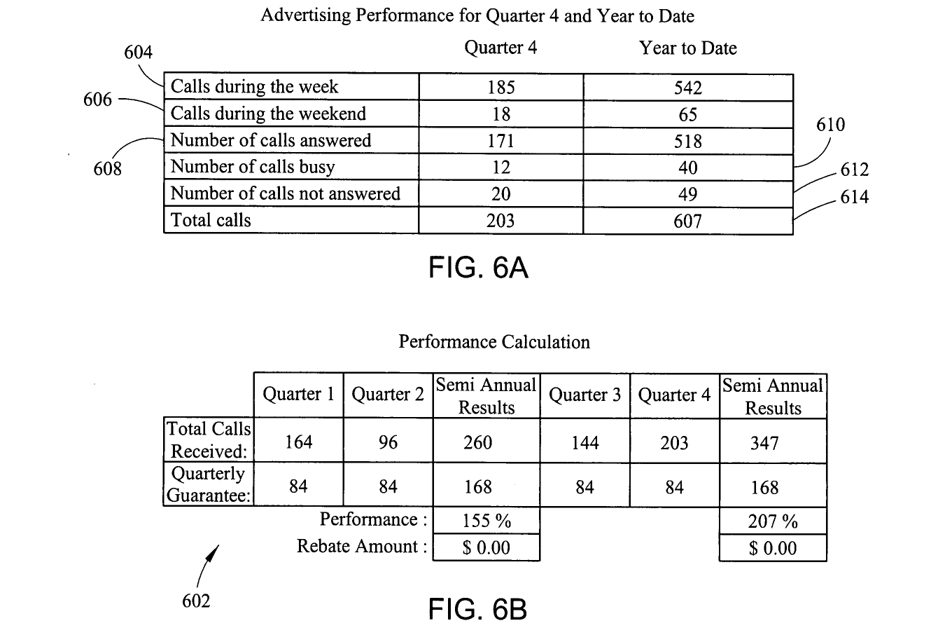

Referring now to FIGS. 6A and 6B, a sample advertising performance report 602 is shown that can be generated by the advertising data processor 122 in association with the report generation module 134. As shown in FIG. 6A, advertising performance data as call volume may be reported for predetermined relevant time periods (e.g., quarterly and year end), including calls during the week 604, calls during the weekend 606, number of calls answered 608, number of calls busy 610, number of calls not answered 612, and total calls 614. As shown in FIG. 6B, advertising performance data may be compiled for the purpose of calculating any applicable rebate owed to the business entity 104 under a contractual arrangement with the telecommunications service provider 101, for example. Under certain guaranteed advertising programs, for example, the telecommunications service provider 101 may agree to compensate the business entity 104 for a call volume of customer 106 communications for a given time period that does not exceed an acceptable level of call volume previously agreed upon between the telecommunications service provider 101 and the business entity 104.

In various embodiments of the present invention, a mapping module 136 may be operatively associated with the advertising data processor 122 to generate or more geographic graphical representations based on the customer 106 communications in step 226. The mapping module 136 may be employed, for example, to generate a map including the location of the business entity 104 and the locations from which customer 106 communications originate. The map may also include market research data, for example, such as data associated with the likelihood of a consumer from a given ZIP code, for example, to purchase a given product or service. The map may also be graphically enhanced (e.g., shading or coloring) to highlight one or more demographic aspects of a given geographic area such as by using the various demographic or census data described hereinabove, for example. In various embodiments, the mapping module 136 may be provided or configured in accordance with one or more trade-designated “MapInfo” products, for example.

It can be appreciated that numerous advertising possibilities are offered to the business entity 104 by embodiments of the present invention. For example, information provided by the reports of the present invention may be employed by the business entity to generate a mailing list of potential customers as part of a direct mail advertising campaign conducted by the business entity 104. Embodiments of the present invention also provide the telecommunications service provider 101 with the opportunity to offer alternative services to the business entity 104 based on comparative data derived from customer 106 communications. For example, the telecommunications service provider 101 may present the business entity 104 with call volume results based on the usage of a comparatively larger advertisement than the size of advertisement 110 currently employed by the business entity 104 in the telephone directory 108. Such comparative call results may be aggregated by the advertising data processor 122 from the experiences of other clients of the telecommunications service provider 101, for example.

It is to be understood that the figures and descriptions of the present invention have been simplified to illustrate elements that are relevant for a clear understanding of the present invention, while eliminating, for purposes of clarity, other elements of a conventional telecommunications system. For example, certain advertising data operating system details and modules of network platforms are not described herein. Those of ordinary skill in the art will recognize, however, that these and other elements may be desirable in a typical telecommunications system or advertising data processing system. However, because such elements are well known in the art and because they do not facilitate a better understanding of the present invention, a discussion of such elements is not provided herein.

Also, in the claims appended hereto, any element expressed as a means for performing a specified function is to encompass any way of performing that function including, for example, a combination of elements that perform that function. Furthermore the invention, as defined by such means-plus-function claims, resides in the fact that the functionalities provided by the various recited means are combined and brought together in a manner as defined by the appended claims. Therefore, any means that can provide such functionalities may be considered equivalents to the means shown herein.

In general, it will be apparent to one of ordinary skill in the art that some of the embodiments as described hereinabove may be implemented in many different embodiments of software, firmware, and hardware in the entities illustrated in the figures. The actual software code or specialized control hardware used to implement some of the present embodiments is not limiting of the present invention. For example, the embodiments described hereinabove may be implemented in computer software using any suitable computer software language type such as, for example, C or C++ using, for example, conventional or object-oriented techniques. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable medium. Such a medium may include any of the forms listed above with respect to storage devices and may further include, for example, a carrier wave modulated, or otherwise manipulated, to convey instructions that may be read, demodulated/decoded and executed by a computer.

It can also be appreciated that certain process aspects described herein may be performed using instructions stored on a computer-readable medium or media that direct a computer system to perform the process aspects. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary. A computer-readable medium may further include one or more data signals transmitted on one or more carrier waves.

A “computer” or “computer system” may be, for example, a wireless or wireline variety of a microcomputer, minicomputer, server, mainframe, laptop, personal data assistant (PDA), wireless e-mail device (e.g., BlackBerry), cellular phone, pager, processor, fax machine, scanner, or any other programmable device configured to transmit and receive data over a network. Computer devices disclosed herein may include memory for storing certain software applications used in obtaining, processing and communicating data. It can be appreciated that such memory may be internal or external to the disclosed embodiments. The memory may also include any means for storing software, including a hard disk, an optical disk, floppy disk, ROM (read only memory), RAM (random access memory), PROM (programmable ROM), EEPROM (electrically erasable PROM), and other computer-readable media.

In various embodiments of the present invention disclosed herein, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

It can be appreciated that the various embodiments of the advertising data processing systems described herein can be readily modified for use with a variety of different languages, nomenclatures, units of measure, data security requirements, privacy requirements, and/or other similarly jurisdictionally or geographically dependent requirements. For example, modifications to computer system or network architecture or database configurations that may be deemed necessary to fulfill data security or data privacy requirements in a certain country, region or jurisdiction are within the scope of the present invention.

While several embodiments of the invention have been described, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as defined by the appended claims.

What is claimed is:

1. In a telecommunications service provider, a method for processing advertising data comprising:
receiving at least one customer communication in a network of the telecommunications service provider, the customer communication including data obtained from at least one advertisement included within an advertisement medium;
forwarding the customer communication to a business entity;
activating an advertising data processor operatively associated with the network in response to receiving the customer communication;
acquiring advertising data associated with the forwarded customer communication with the advertising data processor; and,
accessing at least one directory and at least one other data source with the advertising data processor to obtain data associated with the advertising data acquired from the customer communication, wherein at least one of the other data sources includes demographic data related to the customer communication.

2. The method of claim 1, wherein the advertisement medium includes at least one medium selected from the group consisting of a print advertisement medium and an electronic advertisement medium.

3. The method of claim 2, wherein the telephone directory includes at least one of a residential telephone directory and a commercial telephone directory.

4. The method of claim 1, further comprising triggering at least one announcement in connection with forwarding of the customer communication to the business entity.

5. The method of claim 1, wherein the acquired advertising data include at least one of the following: a telephone number of the customer initiating the customer communication, a duration of the customer communication, an indication of whether a communication between the customer and the business entity was answered or not answered by the business entity, an indication of whether the customer communication resulted in a busy signal, a time of the customer communication, and a date of the customer communication.

6. The method of claim 1, further comprising sending an electronic mail to the business entity when a status of the customer communication is not answered.

7. The method of claim 1, further comprising sending an electronic mail to the business entity when a status of the customer communication results in a busy signal.

8. The method of claim 1, further comprising storing at least a portion of the acquired advertising data in at least one data storage medium.

9. The method of claim 1, wherein the demographic data in the other data source includes census data.

10. The method of claim 1, further comprising cross-referencing the acquired advertising data with the data obtained from at least one of the directory and the other data source.

11. The method of claim 1, further comprising generating at least one report including at least a portion of the acquired advertising data.

12. The method of claim 11, further comprising communicating the report to the business entity via at least one of electronic mail and hard copy mail.

13. The method of claim 11, further comprising generating at least one call detail report including, for a given time period for the business entity, a caller number, caller name, address data for the customer, a class designation for the customer, a status of the customer communication, and a duration of the customer communication.

14. The method of claim 11, further comprising generating at least one call analysis report including at least one graphical representation of at least a portion of the acquired advertising data, the graphical representation including at least one of a calls-by-answer-status section, a percentage-calls-by-day-of-week section, and a calls-by-time-of-day section.

15. The method of claim 11, further comprising generating at least one demographic analysis report including at least a portion of the demographic data.

16. The method of claim 11, further comprising generating at least one advertising performance report including call volume data for a predetermined time period.

17. The method of claim 1, further comprising generating at least one geographical graphical representation based on the acquired advertising data and the demographic data.

18. In a telecommunications service provider, a system for processing advertising data comprising:
a network configured for receiving at least one customer communication from a customer, the customer communication including data obtained from at least one advertisement included within an advertisement medium;
the network being further configured for forwarding the customer communication to a business entity and for activating an advertising data processor in response to receiving the customer communication;
the advertising data processor being configured for acquiring advertising data associated with the forwarded customer communication; and,
the advertising data processor being further configured for accessing at least one directory and at least one other data source to obtain data associated with the advertising data acquired from the customer communication, wherein at least one of the other data sources includes demographic data related to the customer communication.

19. A computer-readable medium including instructions for processing advertising data in a telecommunications service provider, the medium comprising:
instructions for receiving at least one customer communication in a network of the telecommunications service provider, the customer communication including data obtained from at least one advertisement included within an advertisement medium;
instructions for forwarding the customer communication to a business entity;
instructions for activating an advertising data processor operatively associated with the network in response to receiving the customer communication;
instructions for acquiring advertising data associated with the forwarded customer communication with the advertising data processor; and,
instructions for accessing at least one directory and at least one other data source with the advertising data processor to obtain data associated with the advertising data acquired from the customer communication, wherein at least one of the other data sources includes demographic data related to the customer communication.

20. In a telecommunications service provider, a method for processing advertising data comprising:
receiving at least one customer communication in an advanced intelligent network of the telecommunications service provider, the customer communication including data obtained from at least one advertisement included within an advertisement medium;
forwarding the customer communication to a business entity;
activating an advertising data processor with the advanced intelligent network in response to receiving the customer communication;
acquiring advertising data associated with the forwarded customer communication with the advertising data processor;
accessing at least one directory and at least one other data source with the advertising data processor to obtain data associated with the advertising data acquired from the customer communication, wherein at least one of the other data sources includes demographic data related to the customer communication;
generating at least one call detail report including, for a given time period for the business entity, a caller number, caller name, address data for the customer, a class designation for the customer, a status of the customer communication, and a duration of the customer communication between the customer;
generating at least one call analysis report including at least one graphical representation of at least a portion of the acquired advertising data, the graphical representation including at least one of a calls-by-answer-status section, a percentage-calls-by-day-of-week section, and a calls-by-time-of-day section;
generating at least one demographic analysis report including at least a portion of the demographic data; and,
generating at least one advertising performance report including call volume data for a predetermined time period.
